(19) United States
(12) Patent Application Publication
(10) Pub. No.: US 2002/0091961 A1
(43) Pub. Date: Jul. 11, 2002

(54) Microcomputer capable of preventing misidentification of remote control signal due to noise

(76) Inventor: Katsumi Inoue, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/899,172

(22) Filed: Jul. 6, 2001

(30) Foreign Application Priority Data
Jan. 9, 2001 (JP) 2001-1781

(51) Int. Cl. G06F 1/12

(52) U.S. Cl. 713/601

(57) ABSTRACT

A microcomputer includes an external pulse signal capturing section and a clock switching software section. The external pulse signal capturing section, operating in synchronization with a low frequency operation clock signal, captures an external pulse signal such as a remote control signal. The clock switching software section decodes the data portion of the input pulse signal obtained by the external pulse signal capturing section, and switches the operation clock signal from a low frequency operation clock signal to a high frequency operation clock signal when the decoded result is a power-on instruction. The microcomputer can solve a problem of a conventional microcomputer in that it can sometimes misidentify noise input to its remote control terminal as a remote control signal, and hence switches the operation clock signal from a low frequency sub-clock signal in an idle mode to a high frequency main clock signal in a normal operation mode, thereby impairing effective power saving.

### BACKGROUND OF THE INVENTION

1. Field of the Invention

The present invention relates to a microcomputer having a switching function of an operation clock signal, and particularly to a microcomputer that makes a decision as to whether an input signal is a remote control signal or not, and switches the operation clock signal between an idle mode and a normal operation mode.

2. Description of Related Art

To reduce power consumption, some conventional microcomputers comprise a sub-clock oscillator for generating a low frequency operation clock signal (called “sub-clock signal” from now on) with lower power consumption in addition to a main clock oscillator for generating a high frequency operation clock signal (called “main clock signal” from now on) used in a normal operation mode. In the normal operation mode, the CPU operates in synchronization with the main clock signal generated by the main clock oscillator. Entering the idle mode, a CPU switches its operation clock signal to the sub-clock signal generated by the sub-clock oscillator to operate in synchronization with it, thereby reducing the power consumption of the microcomputer.

Here, a concrete operation of a conventional microcomputer with a remote control decision function will be described.

As soon as an external pulse train is supplied to a remote control terminal in the idle mode in which the CPU operates on the sub-clock signal, the rising or falling edges of pulses of the pulse train are detected. The edge detection causes a trigger, an interrupt signal, to be supplied to the CPU that executes its clock switching software, thereby switching the operation clock signal from the sub-clock signal to the main clock signal.

The CPU operating on the main clock signal makes a decision as to the data content of the input pulse train, and when it is a power-on instruction, the CPU turns on the power of the system controlled by the microcomputer.

In contrast, when it is not the power-on instruction, the CPU decides that the input signal instructs to carry out some processing in the idle mode, and hence switches the operation clock signal to the sub-clock signal to enter the idle mode. When no external signal is supplied to the remote control terminal for more than a predetermined period in the idle mode, the CPU halts generating both the sub-clock signal and main clock signal, thereby entering a standby mode that minimizes the power consumption.

In the foregoing microcomputer, every time the edge of the input signal pulse is detected, the CPU is supplied with the interrupt signal, which presents a problem of complicating its software for handling signals such as the remote control signal consisting of a combination of a plurality of pulses.

FIG. 6 is a block diagram showing a configuration of a conventional microcomputer that eliminates the foregoing problem. In this figure, the reference numeral 100 designates a sampling clock counter for sampling an external input signal such as a remote control signal in synchronization with the sampling clock signal, and for counting the number of sampled pulses. The reference numeral 110 designates a sampling clock generator for generating a sampling clock signal in response to a low frequency sub-clock signal supplied from the sub-clock oscillator 160a. The reference numeral 120 designates a header length register for setting a header pulse length in the microcomputer in accordance with the preset remote control format. The reference numeral 130 designates a clock count comparator for comparing the header pulse length in the header length register 120 with the count value of the sampling clock counter 100. The reference numeral 140 designates a main clock/sub-clock switching software section (referred to as “M/S CLK SW section” from now on) for switching the operation clock signal from the sub-clock signal to the main clock signal; and 150 designates a CPU for executing the clock switching software of the M/S CLK SW section 140. The reference numeral 160a designates the sub-clock oscillator for generating the low frequency sub-clock signal; and 160b designates the main clock oscillator for generating the high frequency main clock signal.

Next, the operation of the conventional microcomputer will be described.

In the power-off mode, the CPU 150 operates in synchronization with the sub-clock signal fed from the sub-clock oscillator 160a. When an external pulse train is supplied to a remote control terminal not shown in this figure in this mode, the sampling clock counter 100 in the device detects the rising or falling edge of each signal pulse.

On the other hand, being supplied with the sampling clock signal generated by the sampling clock generator 110 from the sub-clock signal, the sampling clock counter 100 samples the input signal pulses in synchronization with the sampling clock signal, and counts the number of the pulses from the edges it detects. The count value is successively supplied to the clock count comparator 130.

Receiving the count value, the clock count comparator 130 reads the header pulse length stored in the header length register 120 according to the remote control format preset in the microcomputer, and compares it with the count value. In the course of the comparison, when the count value agrees with the header pulse length (that is, when the input pulse train includes the header defined in the remote control signal), the clock count comparator 130 supplies the CPU 150 with the control signal instructing to switch the operation clock signal.

Receiving the control signal, the CPU 150 executes the clock switching software of the M/S CLK SW section 140, and switches the operation clock signal from the sub-clock signal to the main clock signal generated by the main clock oscillator 160b. Thus, the system controlled by the microcomputer operates in synchronization with the high frequency main clock signal.

On the other hand, when the count value differs from the header pulse length, the CPU 150 enters the idle mode waiting for the external pulse train, and operates in synchronization with the sub-clock signal.

With the foregoing configuration, the conventional microcomputer has a problem in that it can sometimes switch the operation clock signal erroneously from the sub-clock signal in the idle mode to the main clock signal in the normal operation mode because of misidentification of the noise input to the remote control terminal as the remote control signal, and hence prevents the power saving of the microcomputer.

The problem will be described in more detail. The conventional microcomputer makes a decision as to whether the external input signal is the remote control signal or not only from the header. Accordingly, when exposed to periodic noise such as that of a fluorescent light, the noise can agree with the content of the header of the remote control signal. Thus, the external input signal other than the remote control signal can be misidentified as the remote control signal so that the operation clock signal is switched from the sub-clock signal in the idle mode to the main clock signal in the normal operation mode.

### SUMMARY OF THE INVENTION

The present invention is implemented to solve the foregoing problem. It is therefore an object of the present invention to provide a microcomputer capable of reducing the misidentification due to noise, and improving the power saving efficiency.

According to a first aspect of the present invention, there is provided a microcomputer that controls its operation clock signal in response to an external pulse signal including a header portion and a data portion with a format preset in the microcomputer, the microcomputer comprising: a reference data storage for prestoring a pulse length of the header portion and a pulse length of the data portion; an external pulse signal capturing section for capturing the external pulse signal in synchronization with a low frequency operation clock signal; a comparator for comparing a header length of the external pulse signal with the pulse length of the header portion fed from the reference data storage, and for comparing a data length of the external pulse signal with the pulse length of the data portion fed from the reference data storage; a data storage for storing the data portion of the external pulse signal when the two comparisons by the comparator are each coincident; and a clock switching section for decoding the data portion of the external pulse signal stored in the data storage, and for switching the operation clock signal from the low frequency operation clock signal to a high frequency operation clock signal when the data portion decoded is a power-on instruction.

Here, the clock switching section may consist of software executed by a CPU.

The external pulse signal capturing section may comprise: edge detecting means for detecting an edge of a pulse of the input pulse signal by using an input of the external pulse signal as a trigger to start operation of the edge detecting means; and clock switching signal output means for outputting, when the edge detecting means detects the edge of the pulse of the input pulse signal, a control signal requesting the CPU to switch the operation clock signal, wherein the clock switching section may halt generating all the operation clock signals when the external pulse signal is not input for more than a predetermined time period in a power-off mode, and switch the operation clock signal in response to at least one of the control signal fed from the clock switching signal output means and the decoded result of the data stored in the data storage.

The external pulse signal capturing section, comprising multiple data storing means for storing data portions of a plurality of external pulse signals, may successively transfer the data prestored in the data storage to the multiple data storing means every time the external pulse signal is input, wherein the clock switching section may successively decode the data portions stored in the multiple data storing means.

The reference data storage may comprise: a header length register for prestoring a header pulse length of the header portion according to the format preset in the microcomputer; and a remote control data decision register prestoring a pulse length of the data portion of the external pulse signal according to the format preset in the microcomputer; wherein the external pulse signal capturing section may comprise a sampling clock counter for sampling the external pulse signal in synchronization with a sampling clock signal, and for counting a number of pulses of the external pulse signal, and wherein the comparator may comprise: a clock count comparator for comparing the header pulse length stored in the header length register with a count value output from the sampling clock counter, and for temporarily storing the data portion of the external pulse signal when they agree; and a comparison data selector for selecting a value stored in one of the header length register and the remote control data decision register, and supplies the selected value to the clock count comparator.

### BRIEF DESCRIPTION OF THE DRAWINGS

FIG. 1 is a block diagram showing a configuration of an embodiment 1 of the microcomputer in accordance with the present invention;

FIG. 2 is a flowchart illustrating a decision operation of the pulses of an external input signal by the microcomputer as shown in FIG. 1;

FIG. 3 is a block diagram showing a configuration of an embodiment 2 of the microcomputer in accordance with the present invention;

FIG. 4 is a flowchart illustrating a decision operation of the pulses of an external input signal by the microcomputer as shown in FIG. 3;

FIG. 5 is a block diagram showing a configuration of an embodiment 3 of the microcomputer in accordance with the present invention; and

FIG. 6 is a block diagram showing a configuration of a conventional microcomputer.

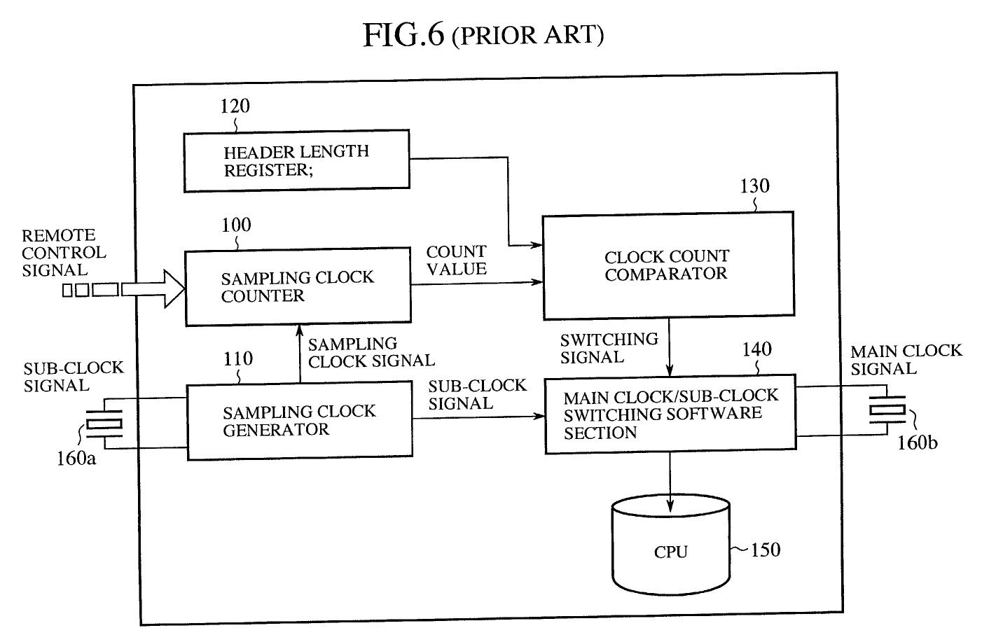

### DETAILED DESCRIPTION OF THE PREFERRED EMBODIMENTS

The invention will now be described with reference to the accompanying drawings.

### EMBODIMENT 1

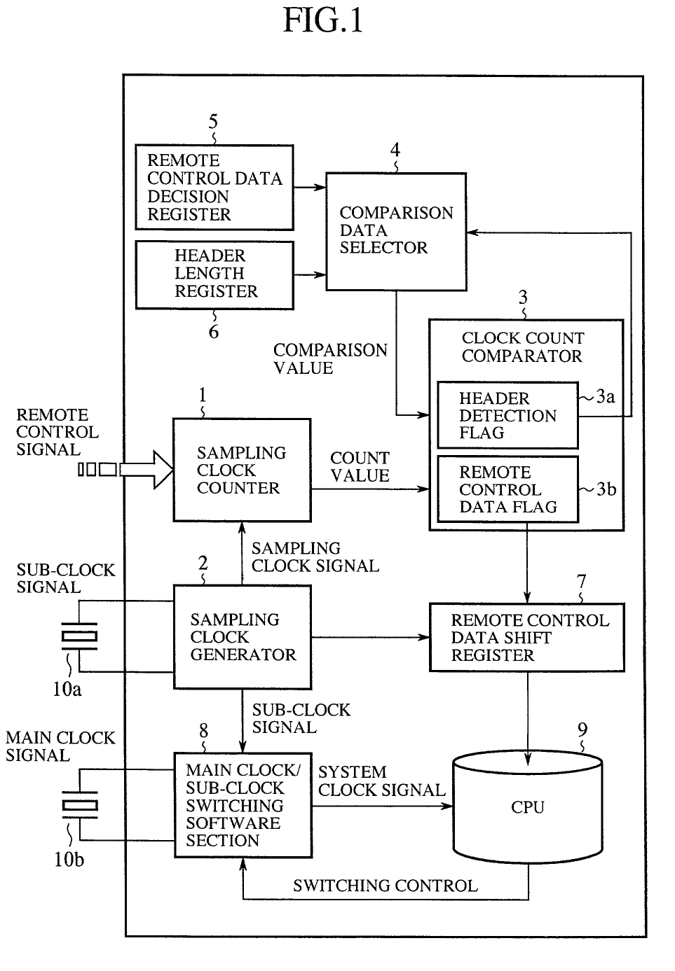

FIG. 1 is a block diagram showing a configuration of an embodiment 1 of the microcomputer in accordance with the present invention. In this figure, the reference numeral 1 designates a sampling clock counter for sampling an external input signal such as a remote control signal in synchronization with a sampling clock signal, and for counting the number of pulses sampled. The reference numeral 2 designates a sampling clock generator for generating the sampling clock signal from a low frequency sub-clock signal supplied from a sub-clock oscillator 10a. The reference numeral 3 designates a clock count comparator that includes a header detection flag 3a and a remote control data flag 3b, and that compares the header pulse length prestored in a header length register 6 with the count value fed from the sampling clock counter 1, and sets or resets the header detection flag 3a or the remote control data flag 3b. The reference numeral 3a designates the header detection flag that is set when the header pulse length stored in the header length register 6 agrees with the count value fed from the sampling clock counter 1; and 3b designates the remote control data flag for successively storing signal pulses following the header (that is the data portion of the input pulse train) that agrees in its length with the value prestored in a remote control data decision register 5.

The reference numeral 4 designates a comparison data selector for selecting either the value stored in the remote control data decision register 5 or the value stored in the header length register 6, and for supplying the selected data to the clock count comparator 3; and 5 designates the remote control data decision register that prestores a pulse length (number) of the pulses with a logic value “1” in the data portion of the remote control signal according to the remote control format preset in the microcomputer. The reference numeral 6 designates the header length register that prestores the header pulse length according to the remote control format preset in the microcomputer. The reference numeral 7 designates a remote control data shift register for successively storing the value stored in the remote control data flag 3b undergoing the decision by the clock count comparator 3 in synchronization with the sampling clock signal.

The reference numeral 8 designates a main clock/sub-clock switching software section (abbreviated to “M/S CLK SW section” from now on) for switching the operation clock signal from the sub-clock to the main clock in response to the decoded result of the content of the remote control data shift register 7; and 9 designates a CPU for executing the clock switching software in the M/S CLK SW section 8. The reference numeral 10a designates a sub-clock oscillator for generating the low frequency sub-clock signal; and 10b designates the main clock oscillator for generating the high frequency main clock signal.

Next, the operation of the present embodiment 1 will be described.

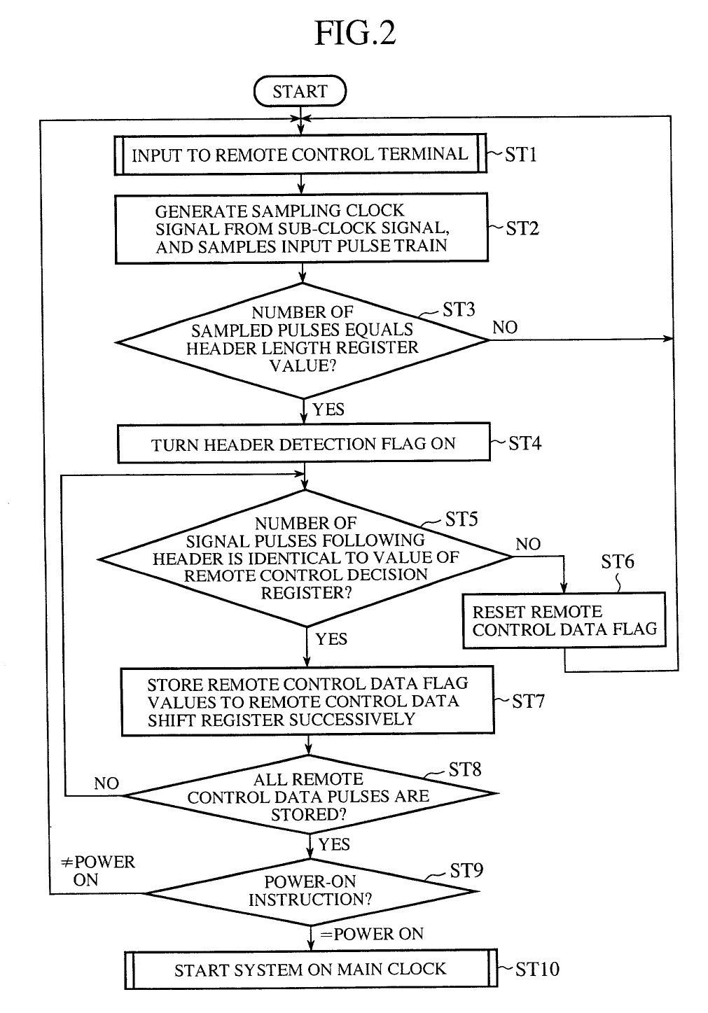

FIG. 2 is a flowchart illustrating a decision operation as to the pulses of the external input signal by the microcomputer as shown in FIG. 1, with reference to which the description will be made.

In the power-off mode, the CPU 9 operates in synchronization with the sub-clock signal supplied from the sub-clock oscillator 10a. When the external pulse train is input in this state to the remote control terminal not shown in FIG. 1, the sampling clock counter 1 in the device detects the rising or falling edges of individual pulses and captures them (step ST1).

On the other hand, the sampling clock counter 1 is supplied with the sampling clock signal generated from the sub-clock signal by the sampling clock generator 2 so that the sampling clock counter 1 samples the input signal pulses in synchronization with the sampling clock signal, and counts the number of the pulses by the edges detected (step ST2) . The count value are supplied to the clock count comparator 3 successively.

At the same time, the comparison data selector 4 selects the header length register 6 using the edge detection by the sampling clock counter 1 as a trigger, and supplies the clock count comparator 3 with the header pulse length that is stored in the header length register 6 according to the preset remote control format.

The clock count comparator 3 receives the count value from the sampling clock counter 1 and the header pulse length from the header length register 6, and compares them (step ST3). If the count value differs from the header pulse length, the clock count comparator 3 makes a decision that the input pulse train is noise rather than the remote control signal, and enters the idle mode that waits for the next external pulse train to be supplied to the remote control terminal.

On the other hand, when the count value agrees with the header pulse length, the clock count comparator 3 makes a decision that the input signal pulse is the remote control signal, and sets a predetermined value in the header detection flag 3a (step ST4). Thus, the first stage of the decision operation of the input pulse train has been completed, at the point of time of which the system operates on the sub-clock signal.

When the predetermined value is set in the header detection flag 3a, the CPU 9 supplies the comparison data selector 4 with the control signal to cause it to select the remote control data decision register 5. Thus, the predetermined pulse length of the data portion of the remote control signal, which is stored in the remote control data decision register 5 in accordance with the remote control format, is supplied to the clock count comparator 3.

In addition, the clock count comparator 3 is supplied with the signal pulses following the header of the input signal from the sampling clock counter 1.

Thus, the clock count comparator 3 compares the length of the signal pulses following the header of the input signal (that is, the data portion of the input pulse train) with the predetermined pulse length of the data portion of the remote control signal stored in advance in the remote control data decision register 5 (step ST5), thereby carrying out the decision operation of the data content of the input signal.

If the data portion of the input pulse train differs in length from the predetermined pulse length of the data portion of the remote control signal, the clock count comparator 3 decides that the input signal pulse is noise rather than the remote control signal, and resets the content of the remote control data flag 3b, and enters the idle mode that waits for the next external pulse train to be supplied to the remote control terminal.

In contrast, when the data portion of the input pulse train agrees in length with the predetermined pulse length of the data portion of the remote control signal, the clock count comparator 3 makes a decision that the input pulse train is the remote control signal, and stores the signal pulses following the header of the input signal corresponding to the data portion of the input pulse train into the remote control data flag 3b.

In the course of this, the content of the remote control data flag 3b is successively shifted to the remote control data shift register 7 every time the input pulse train decided as the remote control signal is captured into the clock count comparator 3 through the sampling clock counter 1 (step ST7) . The operation is iterated until all the data of the input pulse train are stored into the remote control data shift register 7 (step ST8) . Thus, the second stage of the decision operation of the input pulse train has been completed, at the point of time of which the system still operates on the sub-clock signal.

When all the data of the input pulse train is stored in the remote control data shift register 7, the CPU 9 executes the clock switching software of the M/S CLK SW section 8 to decode the data stored in the remote control data shift register 7, and to make a decision as to whether the data is a power-on instruction or not (step ST9).

When the CPU 9 makes a decision that the data is the power-on instruction, it turns on the power of the system, and executes the clock switching software to switch the operation clock signal from the sub-clock signal to the main clock signal fed from the main clock oscillator 10b.

Thus, the system controlled by the microcomputer of the present embodiment 1 starts to operate in synchronization with the high frequency main clock signal.

On the other hand, when the CPU 9 makes a decision that the data is not the power-on instruction, it carries out the processing other than the power-on instruction in synchronization with the sub-clock signal and enters the idle mode that waits for the next external signal pulse to be supplied to the remote control terminal.

As described above, the present embodiment 1 is configured such that it comprises the hardware section, which receives the external pulse train in synchronization with the low frequency operation clock signal and stores its data, in connection with the software section executed by the CPU 9, which decodes the data portion of the input pulse train and switches the operation clock signal from the low frequency to the high frequency when the decoded result is the power-on instruction. Thus, the present embodiment 1 can eliminate the misidentification of the noise produced by a fluorescent light or the like as the remote control signal, and hence reduce the power consumption due to switching of the frequency of the operation clock signal. As a result, it provides a microcomputer capable of improving the efficiency of the power saving.

### EMBODIMENT 2

The present embodiment 2 combines the operation of the foregoing embodiment 1 with that of the conventional system, and tries to further reduce the power consumption by providing a standby mode that stops generating even the sub-clock signal when no signal pulse is input for more than a predetermined time period in the nighttime, for example.

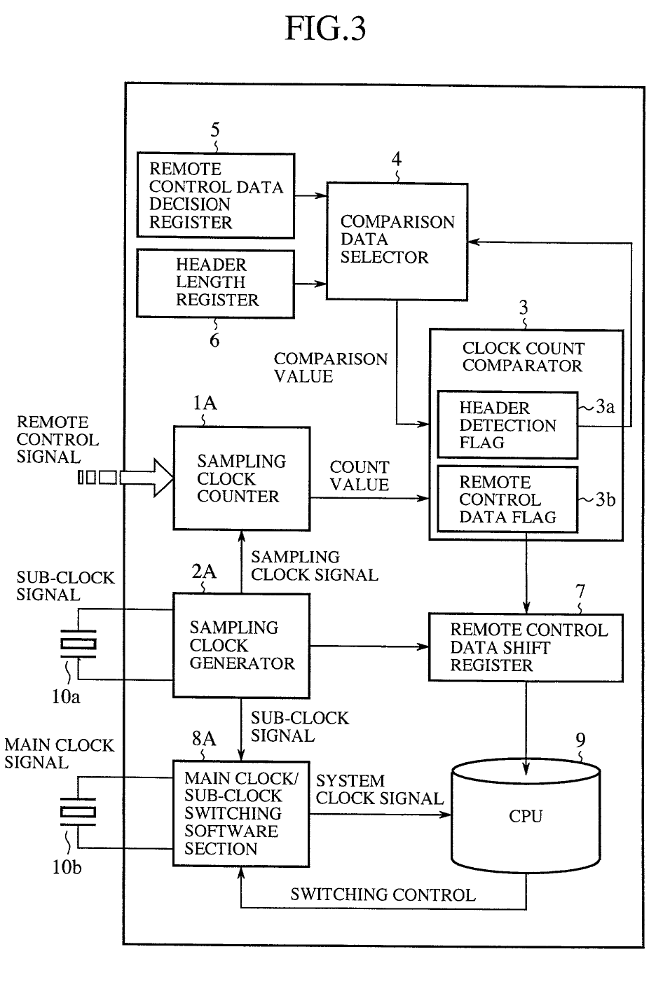

FIG. 3 is a block diagram showing a configuration of the embodiment 2 of the microcomputer in accordance with the present invention. In this figure, the reference numeral 1A designates a sampling clock counter that starts its operation in response to the input of an external pulse train used as a trigger, supplies an interrupt request signal to the CPU 9 in response to the detection of the rising or falling edges of the input signal pulses, samples the input pulse train in synchronization with the sampling clock signal, and counts the number of the sampled pulses. The reference numeral 2A designates a sampling clock generator for generating the sampling clock signal from the sub-clock signal or main clock signal supplied from the sub-clock oscillator 10a or main clock oscillator 10b when the sampling clock counter 1A is supplied with the signal pulses.

The reference numeral 8A designates a main clock/sub-clock switching software section (abbreviated to “M/S CLK SW section” from now on) that switches the operation clock signal in response to the interrupt request signal fed from the sampling clock counter 1A, decodes the content of the remote control data shift register 7, and switches the operation clock signal in accordance with the decoded result. In addition, the M/S CLK SW section 8A halts the generation of all the operation clock signals when no external pulse train is input for more than a predetermined period during the power off. The sampling clock counter 1A, sampling clock generator 2A and M/S CLK SW section 8A can also perform the operations of their counterparts of the foregoing embodiment 1. In FIG. 2, the same components as those of FIG. 1 are designated by the same reference numerals, and the description thereof is omitted here.

Next, the operation of the present embodiment 2 will be described.

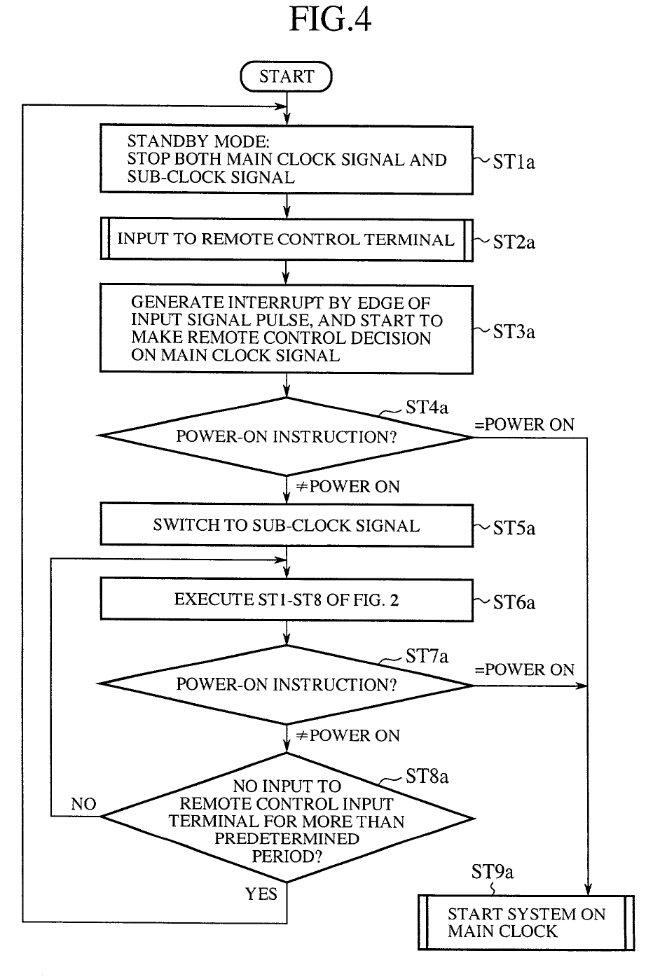

FIG. 4 is a flowchart illustrating a decision operation of the external pulse train by the microcomputer as shown in FIG. 3. The following description will be made with reference to the flowchart of FIG. 4 in connection with the flowchart of FIG. 2 described in connection with the foregoing embodiment 1.

In the case where the power is off and no external pulse train is input for more than a predetermined time period, the CPU 9 executes the M/S CLK SW section 8A to control the sub-clock oscillator 10a and main clock oscillator 10b, thereby entering the standby mode in which none of the operation clock signals are generated (step ST1a).

In this state, when the external pulse train is input to the remote control terminal not shown in FIG. 2 (step ST2a), the sampling clock counter 1A starts its operation so that it detects the rising or falling edges of the input signal pulses and supplies the CPU 9 with the interrupt request signal. In response to the interrupt request signal used as a trigger, the CPU 9 executes the clock switching software of the M/S CLK SW section 8A, and enables the main clock oscillator 10b to operate, thereby switching the operation clock signal to the main clock signal. Thus, the system controlled by the microcomputer starts operating in synchronization with the high frequency main clock signal.

Afterward, in synchronization with the sampling clock signal generated from the main clock signal, the sampling clock counter 1A samples the input pulse train, and counts the number of the pulses by the edges detected. The count value is stored in the remote control data flag 3b in the clock count comparator 3.

In this case, every time the input signal pulse enters the clock count comparator 3 through the sampling clock counter 1A, the content of the remote control data flag 3b is successively stored into the remote control data shift register 7 until all the data of the input pulse train are stored in the remote control data shift register 7 (step ST3a).

Subsequently, when all the data of the input pulse train is stored in the remote control data shift register 7, the CPU 9 executes the M/S CLK SW section 8A to decode the data and to makes a decision as to whether the input pulse train is the power-on instruction or not (step ST4a) . If it decides that the input signal pulse is the power-on instruction, the CPU 9 turns on the power of the system by the software it executes (step ST9a).

On the other hand, when the input pulse train is other than the power-on instruction, the CPU 9 executes the clock switching software of the M/S CLK SW section 8A to switch the operation clock signal from the main clock signal to the sub-clock signal (step ST5a).

After that, when the next external pulse train is input to the remote control terminal, the CPU 9 carries out the steps ST1-ST8 shown in FIG. 2 as described in the foregoing embodiment 1 (step ST6a).

When the CPU 9 makes a decision that the next input pulse train is the remote control signal including its data portion, the clock count comparator 3 stores the signal pulses following the header of the input signal corresponding to the data portion of the input pulse train into the remote control data flag 3b.

In the course of this, every time the input pulse train which is decided as the remote control signal is captured into the clock count comparator 3 through the sampling clock counter 1A, the content of the remote control data flag 3b is successively stored into the remote control data shift register 7 as in the foregoing embodiment 1, which operation is iterated until all the data of the input pulse train is stored into the remote control data shift register 7.

When all the data of the input pulse train is stored in the remote control data shift register 7, the CPU 9 executes the clock switching software of the M/S CLK SW section 8A to decode the data stored in the remote control data shift register 7, and to make a decision as to whether the data is the power-on instruction or not (step ST7a).

When the decision is made that input pulse train is the power-on instruction, the CPU 9 turns on the power of the system by the software it executes (step ST9a).

On the other hand, if the input pulse train is not the power-on instruction, the CPU 9 executes the clock switching software of the M/S CLK SW section 8A, and enters the idle mode that waits for the next external pulse train to be supplied to the remote control terminal (step ST8a). If the next signal pulse train is not input to the remote control terminal for more than the predetermined time period, the CPU 9 executes the M/S CLK SW section 8A to control the sub-clock oscillator 10a and main clock oscillator 10b, to shift to the standby mode that halts generating all the operation clock signals.

As described above, the present embodiment 2 is configured such that it stops generating all the operation clock signals when no external pulse train is input for more than the predetermined time period in the power-off mode, that it detects the edges of the pulses when the external pulse train is input and supplies the CPU 9 with the interrupt request signal to switch the operation clock signal to the main clock signal, that it makes a decision that the processing in the idle mode is to be executed when the data portion of the input pulse train is not the power-on instruction, and switches the operation clock signal to the sub-clock signal, and that it makes a decision, when the external pulse train is input again, as to whether the input pulse train is the remote control signal or not considering the data portion of the signal pulse train as described in the foregoing embodiment 1, followed by making a decision as to whether the data portion is the power-on instruction or not. As a result, the present embodiment 2 can quicken the processing by handling the initially input pulse train, which is received in the standby mode that halts generating the operation clock signal, in the same manner as the conventional operation. At the same time, when the initially input pulse train is not the power-on instruction, the present embodiment 2 carries out the subsequent processing in the same manner as the foregoing embodiment 1. Thus, the present embodiment 2 offers the advantage of the foregoing embodiment 1 in addition to that of the conventional system. Furthermore, when the external pulse signal is not input for more than the predetermined time period, the present embodiment 2 enters the standby mode that prevents all the operation clock signals from being generated. As a result, the present embodiment 2 can reduce the power consumption more effectively than the foregoing embodiment 1.

### EMBODIMENT 3

The present embodiment 3 stores the data of a plurality of input pulse signals into a RAM area successively so that it can reduce the load on the software for making a decision of the input signal.

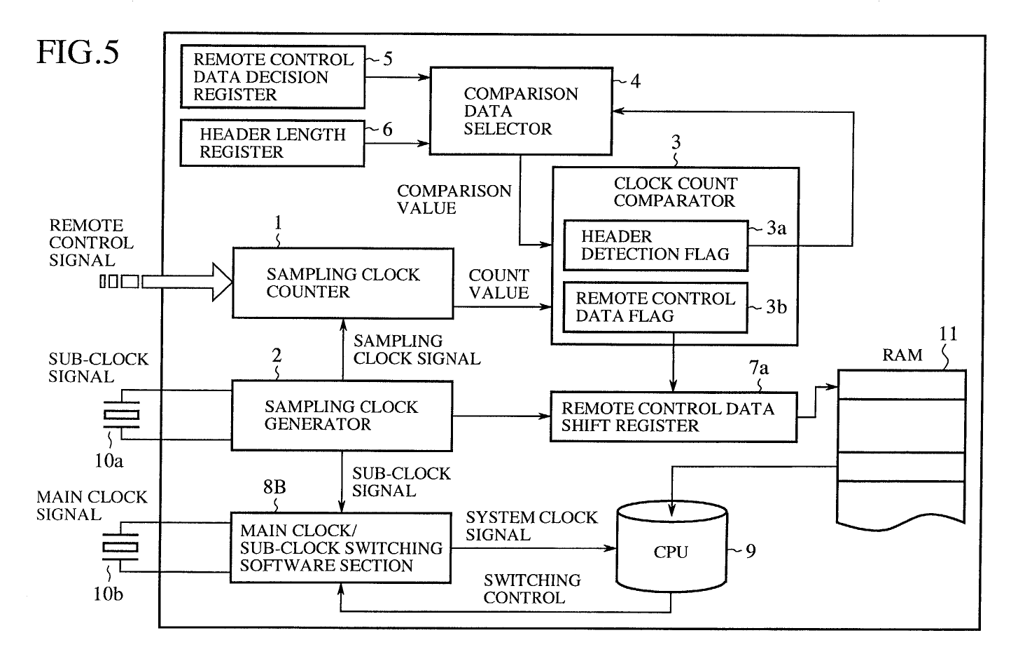

FIG. 5 is a block diagram showing a configuration of the embodiment 3 of the microcomputer in accordance with the present invention. In this figure, the reference numeral 7a designates a remote control data shift register for transferring the data prestored therein to the RAM 11 every time the external pulse signal is input; 8B designates a main clock/sub-clock switching software section (abbreviated to “M/S CLK SW section” from now on) that switches the operation clock signal in response to the control signal output from the clock count comparator 3, decodes the data stored in the RAM 11 successively, and switches the operation clock signal in response to the decoded result. The reference numeral 11 designates the RAM that has the area for storing the data of the input signal transferred from the remote control data shift register 7a, and temporarily stores processing results of the processing by the software executed by the CPU 9. In FIG. 5, the same components as those of FIG. 1 are designated by the same reference numerals, and the description thereof is omitted here.

Next, the operation of the present embodiment 3 will be described.

Since the operation from the input of the external pulse train to the decision of the data portion of the input pulse train is the same as that of the foregoing embodiment 1, the description thereof is omitted here.

Making a decision that the input pulse train is the remote control signal, the clock count comparator 3 stores the signal pulses following the header of the input signal corresponding to the data portion of the input pulse train into the remote control data flag 3b.

In this case, every time the input pulse train that is decided as the remote control signal is captured into the clock count comparator 3 via the sampling clock counter 1, the content of the remote control data flag 3b is successively stored into the remote control data shift register 7a.

In the course of this, when the header of the next input pulse train has the header pulse length indicated by the header length register 6, and the clock count comparator 3 sets the predetermined value to the header detection flag 3a, the remote control data shift register 7a automatically transfers the data currently stored therein to the predetermined area in the RAM 11.

Subsequently, the CPU 9 executes the clock switching software in the M/S CLK SW section 8B to decode the data stored in the RAM 11, and to make a decision as to whether the data is the power-on instruction or not. The subsequent processing is the same as that of the foregoing embodiment 1.

As described above, the present embodiment 3 is configured such that it successively transfers the data stored in the remote control data shift register 7a to the RAM 11 every time the external pulse train is input, and the M/S CLK SW section 8B successively decodes the data stored in the RAM 11. Thus, the present embodiment 3 can make a decision of the content of the remote control signal by reading the data stored in the RAM 11 even when the value in the remote control data shift register 7a is updated by loading the new remote control signal into the register. As a result, the present embodiment 3 can reduce the temporal load of the processing imposed on the M/S CLK SW section 8B.

Incidentally, the configuration of the foregoing embodiment 3 is also applicable to the foregoing embodiment 2, making it possible to achieve the advantages of the respective embodiments.

What is claimed is:

1. A microcomputer that controls its operation clock signal in response to an external pulse signal including a header portion and a data portion with a format preset in the microcomputer, said microcomputer comprising:
a reference data storage for prestoring a pulse length of the header portion and a pulse length of the data portion;
an external pulse signal capturing section for capturing the external pulse signal in synchronization with a low frequency operation clock signal;
a comparator for comparing a header length of the external pulse signal with the pulse length of the header portion fed from said reference data storage, and for comparing a data length of the external pulse signal with the pulse length of the data portion fed from said reference data storage;
a data storage for storing the data portion of the external pulse signal when the two comparisons by said comparator are each coincident; and
a clock switching section for decoding the data portion of the external pulse signal stored in said data storage, and for switching the operation clock signal from the low frequency operation clock signal to a high frequency operation clock signal when the data portion decoded is a power-on instruction.

2. The microcomputer according to claim 1, wherein said clock switching section consists of software executed by a CPU.

3. The microcomputer according to claim 2, wherein said external pulse signal capturing section comprises:
edge detecting means for detecting an edge of a pulse of the input pulse signal by using an input of the external pulse signal as a trigger to start operation of said edge detecting means; and
clock switching signal output means for outputting, when said edge detecting means detects the edge of the pulse of the input pulse signal, a control signal requesting said CPU to switch the operation clock signal, and wherein
said clock switching section halts generating all the operation clock signals when the external pulse signal is not input for more than a predetermined time period in a power-off mode, and switches the operation clock signal in response to at least one of the control signal fed from said clock switching signal output means and the decoded result of the data stored in said data storage.

4. The microcomputer according to claim 1, wherein said external pulse signal capturing section, comprising multiple data storing means for storing data portions of a plurality of external pulse signals, successively transfers the data prestored in said data storage to said multiple data storing means every time the external pulse signal is input, and wherein said clock switching section successively decodes the data portions stored in said multiple data storing means.

5. The microcomputer according to claim 1, wherein said reference data storage comprises: a header length register for prestoring a header pulse length of the header portion according to the format preset in the microcomputer; and a remote control data decision register prestoring a pulse length of the data portion of the external pulse signal according to the format preset in the microcomputer; wherein said external pulse signal capturing section comprises a sampling clock counter for sampling the external pulse signal in synchronization with a sampling clock signal, and for counting a number of pulses of the external pulse signal, and wherein said comparator comprises: a clock count comparator for comparing the header pulse length stored in said header length register with a count value output from said sampling clock counter, and for temporarily storing the data portion of the external pulse signal when they agree; and a comparison data selector for selecting a value stored in one of said header length register and said remote control data decision register, and supplies the selected value to said clock count comparator.
